(19) United States
(12) Patent Application Publication
(10) Pub. No.: US 2010/0078301 A1
(43) Pub. Date: Apr. 1, 2010

(54) KEYBOARD STRUCTURE

(75) Inventor: Liang-Ta Yeh, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/555,910

(22) Filed: Sep. 9, 2009

(30) Foreign Application Priority Data
Sep. 26, 2008 (TW) 97217468

(51) Int. Cl. H01H 13/705

(52) U.S. Cl. 200/344

(57) ABSTRACT

A keyboard structure including a base, a membrane circuit, a keycap, an elastic body and a triggering element is provided. The membrane circuit is disposed on the base. The keycap is disposed upon the membrane circuit. The elastic body is disposed between the membrane circuit and the keycap, and has a first opening and a second opening opposite to the first opening. An edge of the elastic body around the first opening is connected to the membrane circuit, and another edge around the second opening is connected to the keycap. The triggering element, having one end located within the second opening and connected to the keycap, is extended towards the first opening. When the keycap moves toward the base, the other end of the triggering element moves close to the membrane circuit, so as to cause the membrane circuit to generate a signal.

This application claims the benefit of Taiwan application Serial No. 97217468, filed Sep. 26, 2008, the subject matter of which is incorporated herein by reference.

### BACKGROUND OF THE INVENTION

1. Field of the Invention

The invention relates in general to a keyboard structure, and more particularly to a keyboard structure hard to be worn out.

2. Description of the Related Art

Many commonly seen input devices such as mouse, keyboard, and touch pad are already widely used in various computers and hand-held devices. Particularly, electronic products such as desktop computer, notebook computer, mobile phone, personal digital assistant (PDA), smart phone and translation machine are normally equipped with a keyboard for the user to input with. Thus, the operating functions of the keyboard are very important.

Most keyboards have physical press-keys. The user must press the press-key to generate a signal for inputting a command or information to the computer or the hand-held device. However, after a long duration of use, the press-keys on the keyboard must have been pressed or touched for many times, and the elements such as the rubber domes of the press-keys, having been pressed or touched frequently, are likely to wear and tear, hence affecting the operating functions of the press-keys. Thus, the user has to replace the rubber domes that are damaged or worn out or even buy a new keyboard directly.

### SUMMARY OF THE INVENTION

The invention is directed to a keyboard structure. The elastic body has an opening for reducing the bearing surface of the elastic body to avoid the bearing surface being severely deformed and reduce the wear and tear of the elastic body. Thus, the elastic body does not need to be replaced often, and the lifespan of the keyboard structure is prolonged.

According to a first aspect of the present invention, a keyboard structure including a base, a membrane circuit, a keycap, an elastic body and a triggering element is provided. The membrane circuit is disposed on the base. The keycap is disposed upon the membrane circuit. The elastic body is disposed between the membrane circuit and the keycap, and has a first opening and a second opening opposite to the first opening. An edge of the elastic body around the first opening is connected to the membrane circuit, and another edge around the second opening is connected to the keycap. The triggering element, having one end located within the second opening and connected to the keycap, is extended towards the first opening. When the keycap moves toward the base, the other end of the triggering element moves close to the membrane circuit, so as to cause the membrane circuit to generate a signal.

The invention will become apparent from the following detailed description of the preferred but non-limiting embodiments. The following description is made with reference to the accompanying drawings.

### BRIEF DESCRIPTION OF THE DRAWINGS

FIG. 1 shows an explosion diagram of a keyboard structure according to a preferred embodiment of the invention;

FIG. 2A shows the keyboard structure of FIG. 1 after assembly;

FIG. 2B shows the keyboard structure of FIG. 2A being pressed;

FIG. 3 shows that a triggering element and a keycap are independent elements; and

FIG. 4 shows a keyboard structure having a scissors-structure.

### DETAILED DESCRIPTION OF THE INVENTION

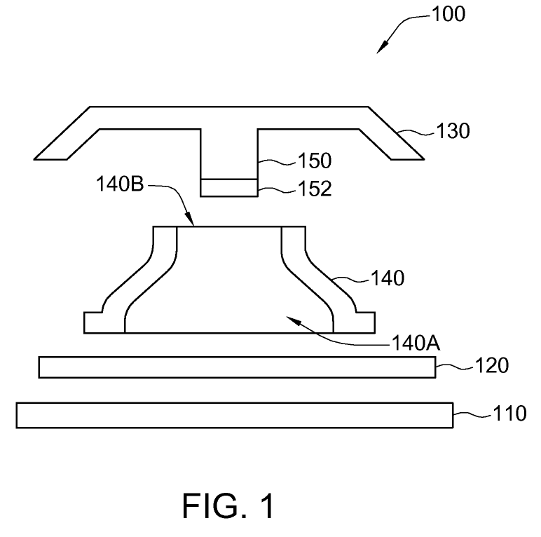

Referring to FIG. 1, an explosion diagram of a keyboard structure according to a preferred embodiment of the invention is shown. As indicated in FIG. 1, the keyboard structure 100 includes a base 110, a membrane circuit 120, a keycap 130, an elastic body 140 and a triggering element 150. The elastic body 140 has a first opening 140A and a second opening 140B opposite to the first opening 140A. When assembling the keyboard structure 100, the membrane circuit 120 is disposed on the base 110 first, and then the elastic body 140 is fixed on the membrane circuit 120. After that, the keycap 130 and the triggering element 150 are aligned to the second opening 140B of the elastic body 140. Lastly, the membrane circuit 120, the keycap 130, the elastic body 140 and the triggering element 150 are together assembled onto the base 110.

The base 110, such as a metal frame or a plastic frame, provides sufficient support and structural strength to the entire keyboard structure 100. The membrane circuit 120 has many press-key switches (not illustrated), wherein, these press-key switches can be formed by a number of thin films printed with metal conductive lines. The keycap 130, which can be a hard keycap or a flexible keycap, is made from engineering plastics or rubber.

The elastic body 140 is a hollowed dome cover for example, wherein the first opening 140A of the elastic body 140 is larger than the second opening 140B, so that the elastic body 140 has different sizes of cross-sections. As indicated in FIG. 1, the elastic body 140 is narrow at the top but is wide at the bottom. Besides, as the elastic body 140 can be made from rubber or plastics, the structure of the elastic body 140 is more flexible when the elastic body 140 has different sizes of cross-sections.

There are openings at the top and the bottom of the elastic body 140 of the present embodiment of the invention. Therefore, unlike the rubber dome of a conventional keyboard which is squeezed by the keycap 130 by the entire surface, the bearing surface (the edge of the second opening 140B) of the elastic body 140 does not generate much deformation when used, so that the wear and tear of the elastic body 140 is reduced, and the lifespan of the elastic body 140 is prolonged.

The triggering element 150 is a column for example. Also, the triggering element 150 and the keycap 130, which can be formed by various injection molding technologies, can be integrally formed in one piece. Preferably, one end of the triggering element 150 has a flexible material 152 for avoiding the surface of the membrane circuit 120 being damaged when the triggering element 150 contacts the membrane circuit 120. Based on the electrical contact of the membrane circuit 120, a conductive material can be disposed at one end of the triggering element 150 for conducting the press-key switch of the membrane circuit 120 through the triggering element 150.

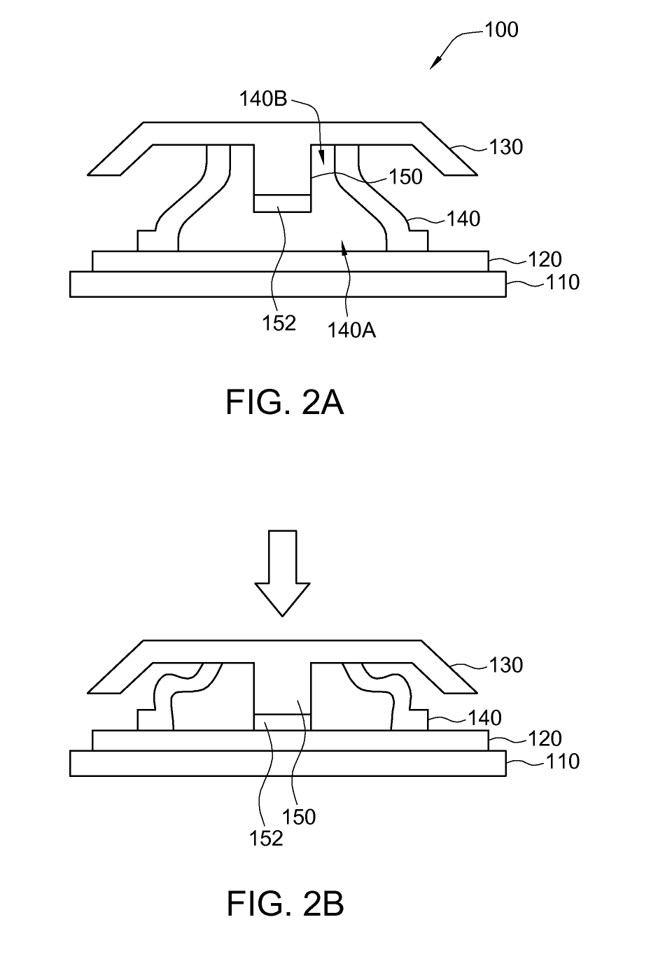

Referring to FIGS. 2A and 2B, FIG. 2A shows the keyboard structure of FIG. 1 after assembly, and FIG. 2B shows the keyboard structure of FIG. 2A being pressed. As indicated in FIG. 2A, after the keyboard structure 100 is assembled, the membrane circuit 120 is disposed on the base 110, and the keycap 130 is disposed upon the membrane circuit 120. The elastic body 140 is located between the membrane circuit 120 and the keycap 130, wherein, an edge of the elastic body 140 around the first opening 140A connects the membrane circuit 120, and another edge around the second opening 140B connects the keycap 130. One end of the triggering element 150 is located within the second opening 140B and connected to the keycap 130, and the other end of the triggering element 150 is extended towards the first opening 140A.

As indicated in FIG. 2B, when the keycap 130 is pressed, the elastic body 140 is deformed such that the keycap 130 is able to move toward the base 110. Meanwhile, the other end of the triggering element 150 moves close to the membrane circuit 120, so as to cause the membrane circuit 120 to generate a signal. Thus, the action of pressing the press-key is completed. When the keycap 130 is released, the keycap 130 restores its original position due to the elastic force of the elastic body 140.

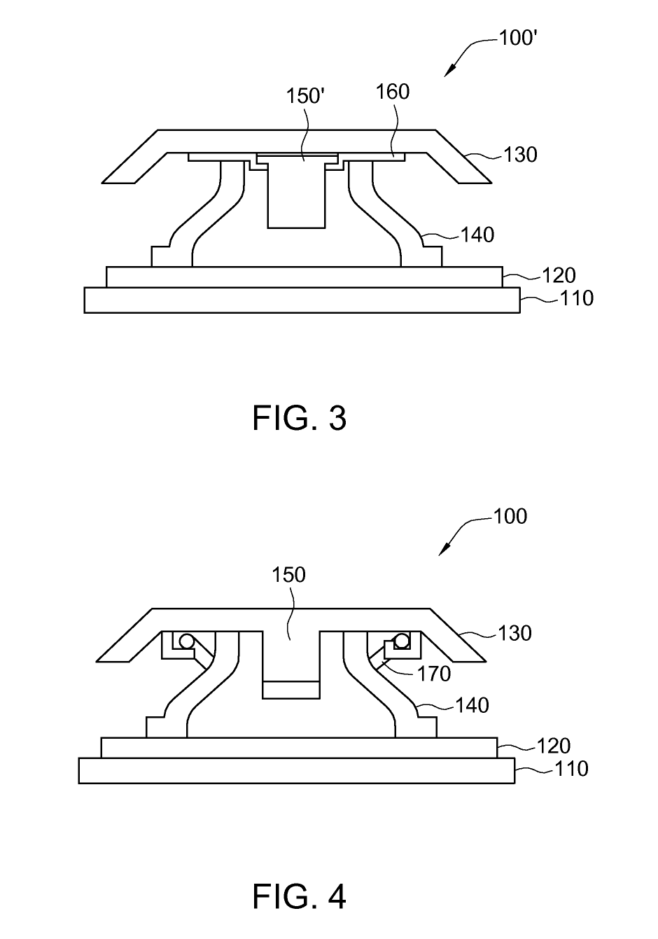

In the above embodiment, the triggering element 150 and the keycap 130 are integrally formed in one piece. However, the invention is not limited thereto. Refer to FIG. 3, which is a diagram showing that a triggering element and a keycap are independent elements. As indicated in FIG. 3, the triggering element 150′ and the keycap 130 can be coupled by a fixing element 160. The fixing element 160 can be a board, entirely attached onto the bottom surface of the keycap 130, wherein one end of the triggering element 150′ is received in the fixing element 160, and the other end penetrates the fixing element 160.

To increase the supporting strength and the pressing stability of the keycap 130 of the keyboard structure 100, other supporting mechanisms can be disposed between the keycap 130 and the base 110. Referring to FIG.4, a keyboard structure having a scissors-structure is shown. As indicated in FIG. 4, a scissors-structure 170 is disposed between the keycap 130 and the base 110. The two linking rods of the scissors-structure 170 are crossed and disposed in the keyboard structure 100, wherein, the two linking rods are coupled by a pivot. One end of each linking rod is connected to the bottom surface of the keycap 130 and the other end is connected on the base 110. When the user presses the keycap 130, in addition to the elastic force of the elastic body 140, the scissors-structure 170 also effectively assists the keycap 130 to stably move upwards and downwards.

According to the keyboard structure disclosed in the above embodiment of the invention, there is an elastic body disposed between the base and the press-key, and the keycap is connected to a triggering element. For enabling the triggering element to contact the membrane circuit, the elastic body has an opening at the position corresponding to the triggering element for allowing the triggering element to penetrate the opening of the elastic body, so that the triggering element can directly trigger the membrane circuit to generate a signal when the keycap is pressed. As there is an opening on the bearing surface of the elastic body corresponding to the keycap, the bearing surface of the elastic body does not generate much deformation during use. Accordingly, the wear and tear of the elastic body is reduced, so there is no need to replace the elastic body often, and the lifespan of the keyboard structure is effectively prolonged.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard structure, comprising:
a base;
a membrane circuit disposed on the base;
a keycap disposed upon the membrane circuit;
an elastic body disposed between the membrane circuit and the keycap, wherein the elastic body has a first opening and a second opening opposite to the first opening, an edge of the elastic body around the first opening is connected to the membrane circuit, and another edge around the second opening is connected to the keycap; and
a triggering element having one end located within the second opening and connected to the keycap, wherein the triggering element is extended towards the first opening, and when the keycap moves towards the base, the other end of the triggering element moves close to the membrane circuit, so as to cause the membrane circuit to generate a signal.

2. The keyboard structure according to claim 1, wherein the triggering element and the keycap are integrally formed in one piece.

3. The keyboard structure according to claim 1, further comprising:
a fixing element used for combining the triggering element and the keycap.

4. The keyboard structure according to claim 3, wherein the fixing element is a board entirely attached on the keycap, and the triggering element penetrates the board.

5. The keyboard structure according to claim 1, wherein the other end of the triggering element has a flexible material.

6. The keyboard structure according to claim 1, wherein the other end of the triggering element has a conductive material.

7. The keyboard structure according to claim 1, wherein the triggering element is a column.

8. The keyboard structure according to claim 1, wherein the first opening is larger than the second opening.

9. The keyboard structure according to claim 1, wherein the elastic body is made from rubber or plastics.

10. The keyboard structure according to claim 1, wherein the elastic body is a dome cover.

11. The keyboard structure according to claim 1, further comprising:
a supporting mechanism disposed between the base and the keycap.

12. The keyboard structure according to claim 11, wherein the supporting mechanism is a scissors-structure.

13. The keyboard structure according to claim 1, wherein the keycap is a hard keycap.

14. The keyboard structure according to claim 1, wherein the keycap is a flexible keycap.
